(19) United States
(12) Patent Application Publication
(10) Pub. No.: US 2015/0112986 A1
(43) Pub. Date: Apr. 23, 2015

(54) METHOD FOR THE DETERMINATION OF SCALABLE REACHABILITY

(71) Applicant: KENT STATE UNIVERSITY, Kent, OH (US)

(72) Inventor: RUOMING JIN, Aurora, OH (US)

(73) Assignee: KENT STATE UNIVERSITY, KENT, OH (US)

(21) Appl. No.: 14/519,576

(22) Filed: Oct. 21, 2014

Related U.S. Application Data
(60) Provisional application No. 61/894,135, filed on Oct. 22, 2013.

(51) Int. Cl. G06F 17/30

(52) U.S. Cl. CPC G06F 17/30958
USPC 707/736

(57) ABSTRACT

Embodiments disclosed herein provide systems and methods for scaling reachability computations on relatively large graphs. In an embodiment, a method provides for scaling reachability computations on relatively large graphs, the method comprising, identifying an initial graph comprising a plurality of vertices and a plurality of edges, processing at least a portion of the plurality of vertices and at least a portion of the plurality of edges to generate a plurality of reachability indices for the at least a portion of the plurality of vertices, and generating a backbone graph comprising a scaled-down version of the initial graph, based at least in part on at least one of the plurality of reachability indices.

### RELATED APPLICATIONS

This application hereby claims the benefit of, and priority to, U.S. Provisional Patent Application 61/894,135, titled “SCALABLE REACHABILITY CALCULATION”, filed Oct. 22, 2013, and which is hereby incorporated by reference in its entirety for all purposes.

### TECHNICAL BACKGROUND

A relational database system is a collection of data items organized as a set of formally described tables from which data can be accessed. These relational databases can become very large, and the response to any query of these databases may require accessing a multitude of databases, each of which may be partially responsive to the query.

Many relational databases, such as in social networks, grow rapidly as data changes with respect to participants and their various natures, features, qualities, and the like. Such a network may be represented by a massive graph, where nodes are connected by edges to other nodes, and both the nodes and edges represent associated relational data.

Previously, the searching of these graphs has been laborious, time consuming, and inordinately and exhaustively detailed, requiring the individual treatment and assessment of each of a multiplicity of nodes and edges. Thus, there is a need for a more effective, efficient, and inexpensive structure, technique, and methodology for undertaking a query in such graphs and networks.

Furthermore, graph data can be stored in a graph database, and the methods and systems described herein can be used on either a graph database, and/or a relational database.

### Overview

Embodiments disclosed herein provide systems and methods for scaling reachability computations on relatively large graphs. In an embodiment, a method provides for scaling reachability computations on relatively large graphs, the method comprising identifying an initial graph comprising a plurality of vertices and a plurality of edges, identifying a backbone graph within the initial graph, creating a subsequent scaled-down version of the initial graph, based at least in part on the backbone graph, and computing the reachability of at least two of the vertices using at least the subsequent graph.

In another embodiment, one or more computer readable storage media having program instructions stored thereon for scaling reachability computations on relatively large graphs that, when executed by a computing system, direct the computing system to at least identifying an initial graph comprising a plurality of vertices and a plurality of edges, identifying a backbone graph within the initial graph, creating a subsequent scaled-down version of the initial graph, based at least in part on the backbone graph, and computing the reachability of at least two of the vertices using at least the subsequent graph.

### BRIEF DESCRIPTION OF THE DRAWINGS

FIG. 1 illustrates a method for scaling reachability computations according to one example.

FIG. 2 illustrates a computing system capable of scaling reachability computations according to one example.

FIG. 3 illustrates an environment for scaling reachability computations according to an example.

FIGS. 4(a)-4(d) illustrate running examples of hierarchical-labeling.

FIG. 4(a) shows a vertex hierarchy for DAG G₀.

FIG. 4(b) shows where V₁={5, 7, 9, . . . , 40}.

FIG. 4(c) shows where V₂={7, 25, 35, 40}.

FIG. 4(d) illustrates the hop labeling for V₀.

FIGS. 5(a)-5(d) illustrate a running example of distribution-labeling.

FIG. 5(a) shows labeling for Cov(13).

FIG. 5(b) shows labeling for Cov({13, 7}).

FIG. 5(c) shows labeling for Cov({13, 7, 25}).

FIG. 5(d) shows basic labeling.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

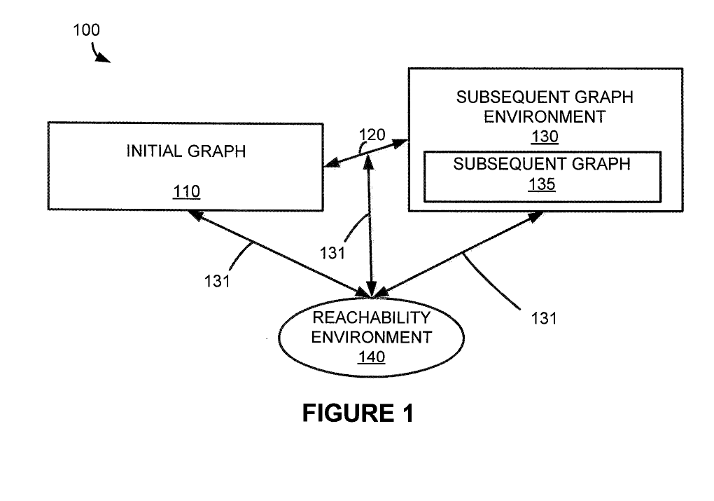

FIG. 1 illustrates a graph reachability environment 100 according to one example. Graph reachability environment 100 includes an initial graph 110, backbone identification or graph 120, subsequent/backbone graph environment 130, and reachability environment 140.

Initial graph 110 may comprises vertices and edges. It may include relational database characteristics. Reachability environment 140 can comprise one or more computer systems configured to query and/or use information from the initial graph 110, backbone 120, and/or subsequent graph 130. Examples of reachability environment 140 can include desktop computers, laptop computers, or any other like device.

An initial graph 110 may be identified. A computing system at subsequent graph environment 130 or reachability environment 140 may then identify a backbone 120. The backbone 120 can be used to create a scaled down, subsequent/backbone graph 135 in subsequent graph environment 130.

Reachability environment 140 may then compute a reachability of vertices within the initial graph 110, using at least one of the initial graph 110, backbone 120, subsequent graph environment 130, and/or subsequent graph 135.

Subsequent graph 135 may be a scaled down version of initial graph 110, such that it may be searched more quickly than initial graph 110. Furthermore, reachability may be calculated faster than reachability within initial graph 110.

Reachability environment 140 may communicate with initial graph 110, backbone 120, and/or subsequent graph environment 130. Reachability environment 140 comprises one or more computer systems configured to compute reachability of the vertices of the initial graph using the initial graph 110 and the subsequent graph 135. Reachability environment 140 and subsequent graph environment 130 can include server computers, desktop computers, laptop computers, or any other similar device—including combinations thereof.

Communication links 131 can use metal, glass, air, space, or some other material as the transport media. Communication links 131 may use various communication protocols, such as Internet Protocol (IP), Ethernet, communication signaling or any other communication format—including combinations thereof.

Although initial graph 110, subsequent graph environment 130, and reachability environment 140 are illustrated as separate environments, graph reachability environment 100 may be implemented in any number of environments, or configurations and may be implemented using any number of computing systems.

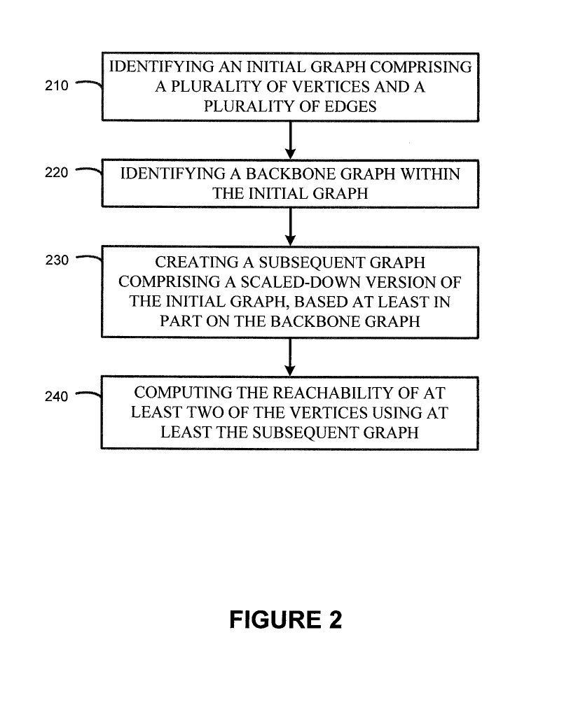

FIG. 2 illustrates a method for graph reachability environment 100 according to one example. In operation reachability environment 140 can identify an initial graph 110, which can include vertices and edges (step 210). In some examples reachability environment 140 can calculate if vertices can be reached. Such calculations can include a function designed to find if there is a path between one item in relational data (a vertice) to another data item in relational data (a second vertice).

Reachability environment 140 and/or subsequent graph environment 130 can identify a backbone graph 120 within the initial graph 110 (step 220). The backbone 120 may be identified using a number of methods, which can include a set cover method and/or a fast cover method and others as described later in this disclosure.

Reachability environment 140 and/or subsequent graph environment 130 can create a subsequent graph 135 comprising a scaled down version of the initial graph 110, using at least the backbone 120 identified in step 220 (step 230). In an example, subsequent graph 135 may include only non-local vertices. Non-local vertices can be vertices further away than a locality threshold from a particular vertice. All vertices may be included in the initial graph 110.

Reachability environment 140 and/or subsequent graph environment 130 can compute the reachability of vertices using at least the subsequent graph 135 (step 240). In an example, reachability environment 140 will calculate the reachability of at least two vertices by using a bidirectional breadth first search the initial graph 110 for local vertices, and the backbone 120 and/or subsequent graph 135 for non-local vertices. Many search techniques and method may be used for searching the subsequent graph 135, as described later in this disclosure.

If the reachability cannot be computed for the local pair within the initial graph 110, then the reachability can be computed for non-local vertices using the backbone 120 and/or the subsequent graph 135. The reachability of vertices can depend on a function of the vertices a particular vertice can reach, and a function of the vertices than can reach the particular vertice. The reachability may also depend on whether vertices can reach the backbone. The reachability of non-local vertices may also be computed in a variety of methods, as described later in this disclosure.

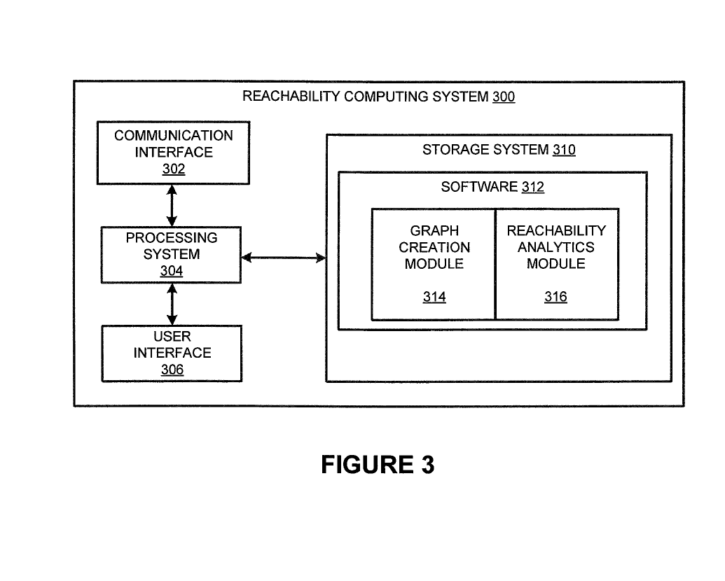

FIG. 3 illustrates a reachability computing system 300 according to one example. Reachability environment 300 can include communication interface 302, processing system 304, user interface 306, storage system 310, and software 312. Processing system 304 loads and executes software 312 from storage system 310.

Software 312 can include graph creation module 314 and reachability analytics module 316. Software 312 may further include an operating system, utilities, drivers, network interfaces, applications, or some other type of software. When executed by unified reachability computing system 300, software modules 314 and 316 direct processing system 304 to operate as a reachability environment as described as in FIG. 2 and the rest of this disclosure.

Although unified reachability computing system 300 includes two software modules in the present example, it should be understood that any number of modules could provide the same operation. Communication interface 302 can communicate using Internet Protocol (IP), Ethernet, communication signaling, or any other communication format.

Referring still to FIG. 3, processing system 304 can comprise a microprocessor and other circuitry that retrieves and executes software 312 from storage system 310. Processing system 304 can be implemented within a single processing device but can also be distributed across multiple processing devices or sub-systems, such as subsequent graph environment 130 and Reachability environment 140, that cooperate in executing program instructions. Examples of processing system 304 include general-purpose central processing units, application specific processors, and logic devices, as well as any other type of processing device, combinations of processing devices, or variations thereof.

Storage system 310 can comprise any storage media readable by processing system 304, and capable of storing software 312. Storage system 310 can include volatile and nonvolatile, removable and non-removable media implemented in any method or technology for storage of information, such as computer readable instructions, data structures, program modules, or other data. Storage system 310 can be implemented as a single storage device but may also be implemented across multiple storage devices or sub-systems. Storage system 310 can comprise additional elements, such as a controller, capable of communicating with processing system 304.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

User interface 306 can include a mouse, a keyboard, a camera, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in user interface 306. The aforementioned user input and output devices are well known in the art and need not be discussed at length here. In some examples, user interface 306 can be omitted.

It should be understood that although reachability computing system 300 is illustrated as a single system for simplicity, the system can comprise one or more systems. For example, in some embodiments graph creation module 314 and reachability analytics module 316 may be divided into separate systems.

Reachability computing system 300 may be used in conjunction with, or be an example of, reachability environment 140 and/or subsequent graph environment 130.

In at least one example, the reachability analytics module 316 may include a reachability function. Such a function will determine if a path exists between one data item to another data item in initial graph 110, backbone 120, and/or subsequent graph 135.

In a particular example, the systems and environments of FIGS. 1-3 use a backbone for scaling down very large graphs, and graph analytics and has the following unique features:

Reachability analysis and calculation is performed by a graph engine in a graph environment, all executed by a computing system.

A reachability oracle (or hop labeling) assigns each vertex v two sets of vertices: Lₒᵤₜ(v) and Lᵢₙ(v), such that u reaches v iff Lₒᵤₜ(u)∩Lᵢₙ(v)≠O/. Despite their simplicity and elegance, reachability oracles have failed to achieve efficiency in more than ten years since their introduction: the main problem is high construction cost, which stems from a set-cover framework and the need to materialize transitive closure. In this disclosure, two simple and efficient labeling algorithms are presented, Hierarchical-Labeling and Distribution-Labeling, which can work on massive real-world graphs: their construction time is an order of magnitude faster than the set-cover based labeling approach, and transitive closure materialization is not needed. On large graphs, their index sizes and their query performance can now beat the state-of-the-art transitive closure compression and online search approaches.

### 1. Introduction

As one of the most fundamental graph operators, reachability has drawn much research interest in recent years and seems to continue fascinating researchers with new focuses and new variants. The basic reachability query answers whether a vertex u can reach another vertex v using a simple path (?u→v) in a directed graph. It has a wide range of applications from software engineering, to distributed computing, to biomedical and social network analysis, to XML and the semantic web, among others.

The majority of the existing reachability computation approaches belong to either transitive closure materialization (compression) or online search. The transitive closure compression approaches tend to be faster but generally have difficulty scaling to massive graphs due to the pre-computation and/or memory cost. Online search is (often one or two orders of magnitude) slower but can work on large graphs. The latest research introduces a unified SCARAB method based on “reachability backbone” (similar to the highway in the transportation network) to deal with their limitations: it can both help scale the transitive closure approaches and speed up online search. However, the query performance of transitive closure approaches tends to be slowed down and they may still not work if the size of the reachability backbone remains too large.

The reachability oracle, more commonly known as hop labeling, is an interesting third category of approaches which lie between transitive closure materialization and online search. Each vertex v is labeled with two sets: Lₒᵤₜ(v), which contains hops (vertices) v can reach; and Lᵢₙ(v), which contains hops that can reach v. Given Lₒᵤₜ(u) and Lᵢₙ(v), but nothing else, we can compute if u reaches v by determining whether there is at least a common hop, Lₒᵤₜ(u)∩Lᵢₙ(v)≠O/. The idea is simple, elegant, and seems very promising: hop labeling can be considered as a factorization of the binary matrix of transitive closure; thus it should be able to deliver more compact indices than the transitive closure and also offer fast query performance.

Unfortunately, after more than ten years since its first proposal and a list of worthy attempts, hop labeling or reachability oracle, still eludes us and still fails to meet its expectations. Despite its appealing theoretical nature, recent studies all seem to confirm its inability to handle real-world large graphs: hop labeling is expensive to construct, taking much longer time than other approaches, and can barely work on large graphs, due to prohibitive memory cost of the construction algorithm. Many studies also show up to an order of magnitude slower query performance compared with the fastest transitive closure compression approaches (though we discover the underlying reason is mainly due to the implementation of hop labeling Lₒᵤₜ and Lᵢₙ; employing a sorted vector/array instead of a set can significantly eliminate the query performance gap).

The high construction cost of the reachability oracle is inherent to the existing labeling algorithms and directly results in the scalability bottleneck. In order to minimize the labeling size, many algorithms rely on a greedy set-cover procedure, which involves two costly operators: 1) repetitively finding densest sub-graphs from a large number of bipartite graphs; and 2) materialization of the entire transitive closure. The latter is needed since each reachability pair needs to be explicitly covered by a selected hop. Even with concise transitive closure representation, such as using geometric format, or reducing the covered pairs using 3-hop, the overall construction complexity is still close to or more than O(n³), which is still too expensive for large graphs. Alternative labeling algorithms try to use graph separators, but only special graph classes, such as planar graphs, consisting of small graph separators, can adopt such techniques well. For general graphs, the scalability of such approach is limited by the lack of good scalable partition algorithms for discovering graph separators on large graphs.

Can the reachability oracle be practical? Is it a purely theoretical concept which can only work on small toy graphs, or it is a powerful tool which can shape reality and can work on real-world large graphs with millions of vertices and edges? Arguably, this is one of the most important unsolved puzzles in reachability computation. This work resolves these questions by presenting two simple and efficient labeling algorithms, Hierarchical-Labeling and Distribution-Labeling, which can work on massive real-world graphs. Their construction costs are as fast as the state-of-the-art transitive closure compression approaches, there is no expensive transitive closure materialization, dense subgraph detection, or greedy set-cover procedure, there is no need for graph separators, and on large graphs, their index sizes and their query performance beat the state-of-the-art transitive closure compression and online search approaches. Using these two algorithms, the power of hop labeling is finally unleashed and a fast, compact and scalable reachability oracle becomes a reality.

### 2. Related Work

To compute the reachability, the directed graph is typically transformed into a DAG (directed acyclic graph) by coalescing strongly connected components into vertices, avoiding the trivial case where vertices reach each other in a strongly connected component. The size of the DAG is often much smaller than that of the original graph and is more convenient for reachability indexing. Let G=(V, E) be the DAG for a reachability query, with number of vertices n=|V| and number of edges m=|E|.

### 2.1 Transitive Closure and Online Search

There are two extremes in computing reachability. At one end, the entire transitive closure (TC) of G is pre-computed and fully materialized (often in a binary matrix). Since the reachability between any pair is recorded, reachability can be answered in constant time, though the O(n²) storage is prohibitive for large graphs. At the other end, DFS/BFS can be employed. Though it does not need an additional index, its query answering time is too slow for large graphs. As mentioned before, the majority of the reachability computation approaches aim to either compress the transitive closure or to speed up the online search.

Transitive Closure Compression: This family of approaches aims to compress the transitive closure—each vertex u records a compact representation of TC(u), i.e., all the vertices it reaches. The reachability from vertex u to v is computed by checking vertex v against TC(u). Representative approaches include chain compression, interval or tree compression, dual-labeling, path-tree, and bit-vector compression. Using interval compress as an example, any contiguous vertex segment in the original TC(u) is represented by an interval. For instance, if TC(u) is {1, 2, 3, 4, 8, 9, 10}, it can be represented as two intervals: [1, 4] and [8, 10].

Existing studies have shown these approaches are the fastest in terms of query answering since checking against transitive closure TC(u) is typically quite simple (linear scan or binary search suffices); in particular, the interval and path-tree approaches seem to be the best in terms of query answering performance. However, the transitive closure materialization, despite compression, is still costly. The index size is often the reason these approaches are not scalable on large graphs.

Fast Online Search: Instead of materializing the transitive closure, this set of approaches aims to speed up the online search. To achieve this, auxiliary labeling information per vertex is pre-computed and utilized for pruning the search space. Using the state-of-the-art GRAIL as an example, each vertex is assigned multiple interval labels where each interval is computed by a random depth-first traversal. The interval can help determine whether a vertex in the search space can be immediately pruned because it never reaches the destination vertex v.

The pre-computation of the auxiliary labeling information in these approaches is generally quite light; the index size is also small. Thus, these approaches can be applicable to very large graphs. However, the query performance is not appealing; even the state-of-the-art GRAIL can be easily one or two orders of magnitude slower than the fast interval and path-tree approaches. For very large graphs, these approaches may be too slow for answering reachability query.

### 2.2 Reachability Oracle

The reachability oracle, also refer to as hop labeling, was pioneered by Cohen et al.. Though it also encodes transitive closure, it does not explicitly compress the transitive closure of each individual vertex independently (unlike the transitive closure compression approaches). Here, each vertex v is labeled with two sets: Lₒᵤₜ(v), which contains hops (vertices) v can reach; and Lᵢₙ(v), which contain hops that can reach v. Given Lₒᵤₜ(u) and Lᵢₙ(v), but nothing else, we can compute if u reaches v by determining whether there is a common hop, Lₒᵤₜ(u)∩Lᵢₙ(v). In fact, a reachability oracle can be considered as a factorization of the binary matrix of transitive closure; and thus more compact indices are expected from such a scheme.

The seminal 2-hop labeling aims to minimize the reachability oracle size, which is the total label size Σ(|Lₒᵤₜ(u)|+|Lᵢₙ(u)|). It employs an approximate (greedy) algorithm based on set-covering which can produce a reachability oracle with size no larger than the optimal one by a logarithmic factor. The optimal 2-hop index size is conjectured to be Õ(nm^{1/2}). The major problem of the 2-hop indexing approach is its high construction cost, which needs to iteratively find dense sub-graphs from a large number of bipartite graphs (representing the covering of transitive closure). Its computational cost is O(n³|TC|), where |TC| is the total size of transitive closure. A number of approaches have sought to reduce construction cost through speeding up the set cover procedure, using concise transitive closure representation, or reducing the covered pairs using 3-hop. However, they still need to repetitively find densest sub-graphs and to materialize the transitive closure. Alternative labeling algorithms try to use graph separators, but only special graph classes, such as planar graphs, consisting of small graph separators, can adopt such technique well. For general graphs, the scalability of such approach is limited by the lack of good scalable partition algorithms for discovering graph separators on large graphs.

### 2.3 Reachability Backbone and SCARAB

In the latest study a general framework is introduced, referred to as SCARAB (SCAling ReachABility), for scaling the existing reachability indices (including both transitive closure compression and hop labeling approaches) and for speeding up the online search approaches. The central idea is to leverage a “reachability backbone”, which carries the major “reachability flow” information. The reachability backbone is similar in spirit to the highway structure used in several state-of-the-art shortest path distance computation methods on road networks. However, the SCARAB work is one of the first studies to construct and utilize such structure in the reachability computation.

Formally, the reachability backbone G*=(V*, E*) of graph G is defined as a subgraph of the transitive closure of G (E*⊂TC(G)), such that for any reachable (u, v) pair, there must exist local neighbors u*∈V*, v*∈V* with respect to locality threshold ε, i.e., d(u, u*)≦ε and d(v*, v)≦ε, and u*→v*. Here d(u, u*) is the shortest path distance from u to u* where the weight of each edge is unit. To compute the reachability from u to v, u collects a list of local outgoing backbone vertices (entries) using forward BFS, and v collects a list of local incoming backbone vertices (exits) using backward BFS. Then an existing reachability approach can be utilized to determine if there is a local entry reaching a local exit on the reachability backbone G*.

Two algorithms are developed to approximate the minimal backbone, one based on set-cover and the other based on BFS. The latter, referred to as FastCover, is particularly efficient and effective, with time complexity O(Σ_{v∈V}|N_{ε}(v)|log|N_{ε}(v)|+|E_{ε}(v)|), where N_{ε}(v) (E_{ε}(v)) is the set of vertices (edges) v can reach in ε steps. Experiments show that even with ε, the size of the reachability backbone is significantly smaller than the original graph (about 1/10 the number of vertices of the original graph). As we will discuss later, our first Hierarchical-Labeling algorithm is directly inspired by the reachability backbone and effectively utilizes it for reachability oracle construction.

Though the scaling approach is quite effective for helping deal with large graphs, it is still constrained by the power of the original index approaches. For many large graphs, the reachability backbone can still be too large for them to process as shown in the experiment study in. Also, using the reachability backbone slows down the query performance of the transitive closure compression and hop labeling approaches (typically two or three times slower than the original approaches) on the graphs where they can still run. In addition, theoretically, the reachability backbone could be applied recursively; this may further slow down query performance.

We also note that a new variant of reachability queries, k-hop reachability, is introduced and studied. It asks whether vertex u can reach v within k steps. This problem can be considered a generalization of the basic reachability, where k=∞. A k-reach indexing approach is developed and the study shows that approach can handle basic reachability quite effectively (with comparable query performance to the fastest transitive closure compression approaches on small graphs). The k-reach indexing approach is based on vertex cover (a set of vertices covers all the edges in the graph), and it actually produces a reachability backbone with ε=1. But this study directly materializes the transitive closure between any pair of vertices in the vertex cover, where in other studies, the existing reachability indices are used. Thus, for very large graphs where the vertex cover is often large, the pair-wise reachability materialization is not feasible.

### 2.4 Other Related Works

Distance 2-HOP Labeling: The 2-hop labeling method proposed by Cohen et al. can also handle the exact distance labeling. Here, each vertex u records a list of intermediate vertices OUT(u) which it can reach along with their (shortest) distances, and a list of intermediate vertices IN(u) which can reach it along with their distances. To answer the point-to-point shortest distance query from u to v, we simply need to check all the common intermediate vertices between OUT(u) and IN(v) and choose the vertex p, such that dist(u, p)+dist(p, v) is minimized for all p∈OUT(u)∩IN(v). However, its computational cost (similar to the reachability 2-hop labeling) is too expensive even for graphs with hundreds of thousands of vertices.

Recently, Abraham et al. have developed a fast and practical algorithm to heuristically construct the distance labeling on large road networks. In particular, they utilize contraction hierarchies (CH) which transform the original graph into a level-wise structure, and then assign the maximum-rank vertex on the shortest path between s and t as the hop for s and t. However, the core of CH needs to iteratively remove vertices and then add shortcuts for fast shortest path computation. Due to the power-law property, such operation easily becomes very expensive for general graphs. For example, to remove a vertex with thousands of neighbors may require checking millions of potential shortcuts. Interestingly, another state-of-the-art method, Path-Oracle by Sankaranarayanan et al., utilizes a spatial data structure for distance labeling on road networks. In a study, a highway-centric labeling approach to label large sparse graphs was proposed. The basic idea is to utilize a highway structure, such as a spanning tree, to reduce the computational cost of labeling as well as to reduce the labeling size. However, it still has a scalability bottleneck as it needs to partially materialize the transitive closure for directed graphs.

Relationship to the latest reachability labeling and distance labeling papers: Cheng et al. have developed a reachability labeling approach, referred to as TF-label. Their approach is similar to the Hierarchical Labeling (HL) approach being introduced in this work. In particular, it can be considered a special case of HL where ε=1 (Section 4). The hierarchy being constructed is based on iteratively extracting a reachability backbone with ε=1, inspired by independent sets. A similar approach has been used in their earlier work on distance labeling, referred to as IS-labeling. In this disclosure, the hierarchy structure is extracted based on the reachability backbone approach, which has been shown to be effective and efficient for scaling reachability computation. In another recent work, Akiba et al. have proposed a distance labeling approach, referred to as the Pruned Landmark. This approach is similar in spirit to the Distribution Labeling (DL) approach. However, DL performs BFS in both directions (forward and reverse) in order to handle reachability labeling. Also, the condition for assigning labels is different.

### 3. Approach Overview

In a reachability oracle of graph G, each vertex v is labeled with two sets: Lₒᵤₜ(v), which contains hops (vertices) v can reach; and Lᵢₙ(v), which contain hops that can reach v. A labeling is complete if and only if for any vertex pair where u→v, Lₒᵤₜ(u)∩Lᵢₙ(v) 6=O/. The goal is to minimize the total label size, i.e., Σ(|Lₒᵤₜ(u)|+|Lᵢₙ(u)|). A smaller reachability oracle not only help to fit the index in main memory, but also speeds up the query processing (with O(|Lₒᵤₜ(u)|+|Lᵢₙ(v)|) time complexity).

As mentioned before, though the existing set-cover based approaches can achieve approximate optimal labeling size within a logarithmic factor, its computational and memory cost is prohibitively expensive for large graphs. The labeling process not only needs to materialize the transitive closure, but it also uses an iterative set-cover procedure which repetitively invokes dense subgraph detection. The reason for such complicated algorithm is that the following two criteria need to be met: 1) a labeling must be complete, and 2) we wish the labeling to be minimal. The existing approach essentially transforms the labeling problem into a set cover problem with the cost of constructing the ground set (which is the entire transitive closure) and dynamic generation and selection of good candidate sets (through dense subgraph detection).

To achieve efficient labeling which can work on massive graphs, the following issues have to appropriately handled:

1. (Completeness without Transitive Closure): Can we guarantee labeling completeness without materialization of the transitive closure? Even compact or reduced materialization can be expensive for large graphs. Thus, the key is whether a labeling process can avoid the need to explicitly check whether a reachable pair (against some form of transitive closure) is covered by the existing labeling.

2. (Compactness without Optimization): Without the set-cover, it seems difficult to produce bounded approximate optimal labeling. But this does not mean that a compact reachability oracle cannot be produced. Clearly, each vertex should not record every valid hop in the labeling. In the set-cover framework, a price is computed to determine whether a vertex should be added to certain vertex labels. What other criteria can help determine the importance of hops (vertices) so that each vertex can be more selective in what it records?

In this disclosure, we investigate how the hierarchical structure of a DAG can help produce a complete and compact reachability oracle. The basic idea is as follows: assuming a DAG can be represented in a hierarchical (multi-level) structure, such that the lower-level reachability needs to go through upper-level (but vice versa), then we can somehow recursively broadcast the upper-level labels to lower-level labels. In other words, the labels of lower-level vertices (Lᵢₙ and Lₒᵤₜ) can directly utilize the already computed labels in the upper-level. Thus, on one side, by using the hierarchical structure, the completeness of labeling can be automatically guaranteed. On the other side, it provides an importance score (the level) of every hop; and each vertex only records those hops whose levels are higher than or equal to its own level. Note that there have been several studies using the hierarchical structure for shortest path distance computation on road networks; however, how to construct and utilize the hierarchical structure for reachability computation has not been fully addressed. This is the first study to construct a fast and scalable reachability oracle based on hierarchical DAG decomposition.

Now, to turn such an idea into a fast labeling algorithm for reachability oracle, the following two research questions need to be answered: 1) What hierarchical structure representation of a DAG can be used? 2) How should Lₒᵤₜ and Lᵢₙ be computed efficiently using a given hierarchical structure? In this disclosure, e two fast labeling algorithms based on different hierarchical structures of a DAG are introduced:

Hierarchical-Labeling (Section 4): In this approach, the hierarchical structure is produced by a recursive reachability backbone approach, i.e., finding a reachability backbone G* from the original graph G and then applying the backbone extraction algorithm on G*. Recall that the reachability backbone is introduced by the latest SCARAB framework which aims to scale the existing reachability computation approaches. Here we apply it recursively to provide a hierarchical DAG decomposition. Given this, a fast labeling algorithm is designed to quickly compute Lᵢₙ and Lₒᵤₜ one vertex by one vertex in a level-wise fashion (from higher level to lower level).

Distribution-Labeling (Section 5): In this approach, the sophisticated reachability backbone hierarchy is replaced with the simplest hierarchy a total order, i.e., each vertex is assigned a unique level in the hierarchy structure. Given this, instead of computing Lᵢₙ and Lₒᵤₜ one vertex at a time, the labeling algorithm will distribute the hop one by one (from higher order to lower order) to Lᵢₙ and Lₒᵤₜ of other vertices. The worst case computation complexity of this labeling algorithm is O(n(n+m)) (of the same order as transitive closure computation), though in practice it is much faster than the transitive closure computation.

Through an extensive study on both real and synthetic graphs, we found that both labeling approaches not only are fast (up to an order of magnitude faster than the best set-cover based approach) and work on massive graphs, but most surprisingly, their label sizes are actually smaller than the set-cover based approaches.

### 4. Hierarchical Labeling

Before we proceed to discuss the Hierarchical Labeling approach, let us formally introduce the one-side reachability backbone (first defined for scaling the existing reachability computation), which serves as the basis for hierarchical DAG decomposition and the labeling algorithm.

Definition 1

(One-Side Reachability Backbone) Given DAG G, and local threshold ε, the one-side reachability backbone G*=(V*, E*) is defined as follows: 1) V*⊂V, such that for any vertex pair (u, v) in G with d(u, v)=ε, there is a vertex v* with d(u, v*)≦ε and d(v*, v)≦ε; 2) E* includes the edges which link vertex pair (u*, v*) in V* with d(u*, v*)≦ε+1.

Note that E* can be simplified as a transitive reduction (the minimal edge set preserving the reachability). Since computing transitive reduction is as expensive as transitive closure, rules like the following can be applied: (u*, v*)∈E* can be removed if there is another intermediate vertex x∈V* (not u* and v*) with d(u*, x)≦ε and d(x, v*)≦ε. To facilitate our discussion, for any two vertices u and v, if their distance is no higher than ε (local threshold), we refer to them as being a local pair (or being local to one another).

### Example 4.1

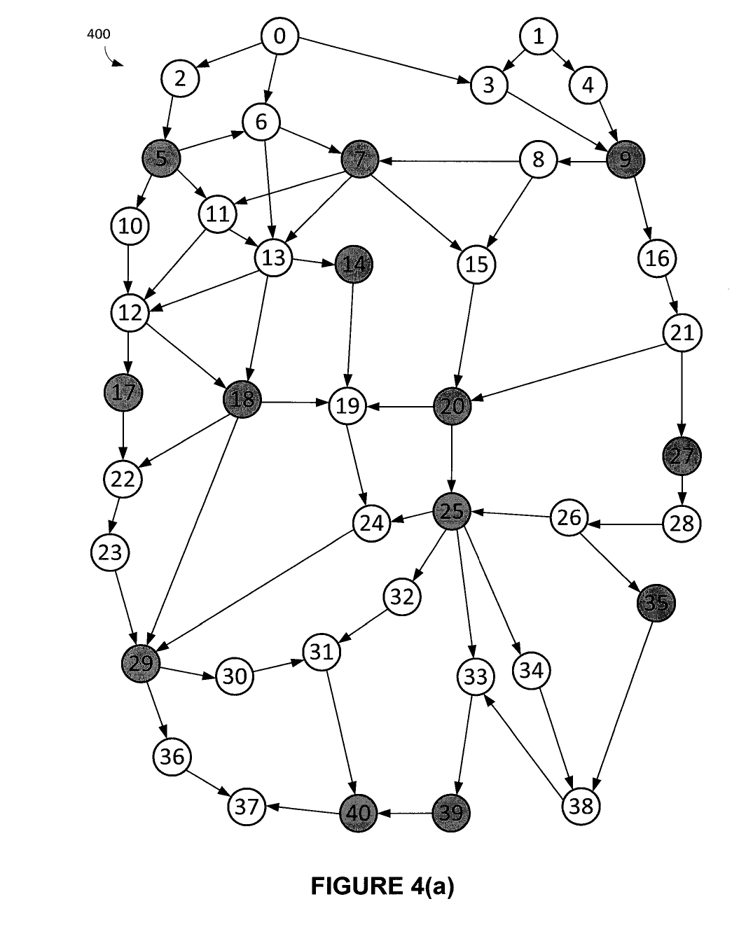

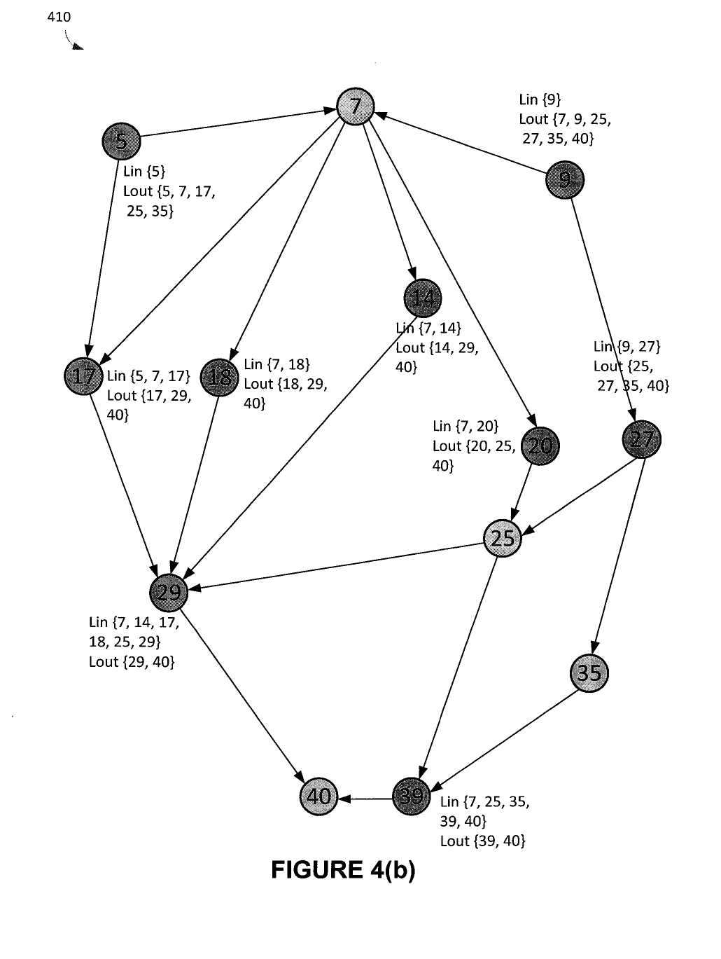

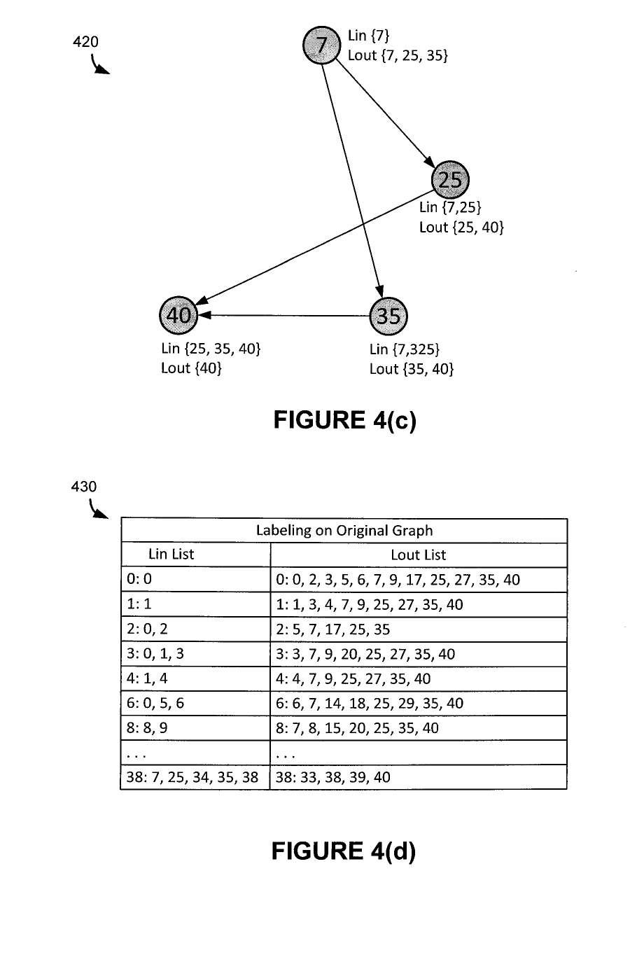

As a simple example, let V* be a vertex cover of G, i.e., at least one end of an edge in E is in V*; and let E* contain all edges (u*, v*)∈V*×V*, such that d(u*, v*)≦2. Then, G*=(V*, E*) is one-side reachability backbone with ε=1. In FIG. 4(b), G₁ is the first level reachability backbone 410 of original graph G₀ (400 in FIG. 4(a)) for ε=2.

The important property of the one-side reachability backbone is that for any non-local pair (u, v): u→v and d(u, v)>ε, there always exists u*∈V* and v*∈V*, such that d(u, u*)≦ε, d(v*, v)≦ε, and u*→v*. This property will serve as the key tool for recursively computing Lₒᵤₜ and Lᵢₙ. The FastCover algorithm is developed employing ε-step BFS for each vertex for discovering the one-side reachability backbone. They also show that when ε=2, the backbone can already be significantly reduced. To simplify our discussion, in this disclosure, we will focus on using the reachability backbone with ε=2 though the approach can be applied to other locality threshold values.

Below, Subsection 4.1 presents the hierarchical decomposition of a DAG and the labeling algorithm using this DAG; Subsection 4.2 discusses the correctness of the labeling approach and its time complexity.

### 4.1 Hierarchical DAG Decomposition and Labeling Algorithm

Let us start with the hierarchical DAG decomposition which is based on the reachability backbone.

Definition 2

(Hierarchical DAGDecomposition) Given DAG G=(V, E), a vertex hierarchy is defined as V₀=V⊃V₁⊃V₂⊃ . . . ⊃Vₕ, with corresponding edge sets E₀, E₁, E₂ . . . Eₕ, such that Gᵢ=(Vᵢ, Eᵢ) is the (one-side) reachability backbone of Gᵢ₋₁=(Vᵢ₋₁, Eᵢ₋₁), where 0<i≦h. The final graph Gₕ=(Vₕ, Eₕ) is referred to as the core graph.

Intuitively, the vertex hierarchy shows the relative importance of vertices in terms of reachability computation. The lower level reachability computation can be resolved using the higher level vertices, but not the other way around. In other words, the reachability (backbone) property is preserved through the vertex hierarchy.

Lemma 1

Assuming u∈Vᵢ, v∈Vᵢ, u reaches v in G (u [symbol] v) iff u reaches v in Gᵢ (u [symbol] v). Furthermore, for any non-local vertex pairs (uᵢ, vᵢ)∈Vᵢ, d(uᵢ, vᵢ|Gᵢ)>ε (the distance in Gᵢ), there always exists uᵢ+1∈Vᵢ+1 and vᵢ+1∈Vᵢ+1, such that d(uᵢ, uᵢ+1|Gᵢ)≦ε, d(vᵢ+1, vᵢ|Gᵢ)≦ε, and uᵢ+1 [symbol] vᵢ+1.

Proof Sketch: The first claim: assuming u∈Vᵢ, v∈Vᵢ, u reaches v in G(u [symbol] v) iff u reaches v in Gᵢ (u [symbol] v), can be proved by induction. The base case where i=1 is clearly true based on the reachability backbone definition (the reachability backbone will preserve the reachability between vertices in the backbone as they appear in the original graph). Assuming this is true for all i<k, then it also holds to be true for i=k. This is because for any u∈Vᵢ, v∈Vᵢ we must have u∈Vᵢ−1 and v∈Vᵢ−1. Based on the reachability backbone definition, we have u [symbol] iff u [symbol] v. Then based on the induction, we have G(u [symbol] v) iff u reaches v in Gᵢ(u [symbol] v). The second claim directly follows the reachability definition.

### Example 4.2

FIG. 4(a) shows a vertex hierarchy for DAG G₀ 400, FIG. 4(b) shows where V₁={5, 7, 9, . . . , 40} 410, and FIG. 4(c) shows where V₂={7, 25, 35, 40} 420. G₁ 410 is the (one-side) reachability backbone of G₀ and G₂ 420 is the corresponding (one-side) reachability backbone of G₁. FIG. 4(d) illustrates the hop labeling for V₀ 430.

To utilize the hierarchical decomposition for labeling, let us further introduce a few notations related to the vertex hierarchy. Each vertex v is assigned to a unique level: level(v)=i iff v∈Vᵢ\Vᵢ₊₁, where 0≦i≦h and Vₕ₊₁=O/. (Later, we will show that each vertex is labeled at its corresponding level using Gᵢ and labels of vertices from higher levels). Assuming v is at level i, i.e., level(v)=i, let Nₒᵤₜ^{k}(v|Gᵢ) (Nᵢₙ^{k}(v|Gᵢ)) be the v's k-degree out-going (incoming) neighborhood, which includes all the vertices v can reach (reaching v) within k steps in Gᵢ. Finally, for any vertex v at level i<h, its corresponding outgoing (incoming) backbone vertex set Bₒᵤₜ^{∈}(v) (Bᵢₙ^{∈}(v)) is defined as:

Bₒᵤₜ^{∈}(v)={u∈Vᵢ₊₁|d(v,u|Gᵢ)≦ε and there is no other vertex x∈Vᵢ₊₁, such that d(v,x|Gᵢ)≦ε̂d(x,u|Gᵢ)≦ε(v→x→u)} (1)

Bᵢₙ^{∈}(v)={u∈Vᵢ₊₁|d(u,v|Gᵢ)≦ε and there is no other vertex y∈Vᵢ₊₁, such that d(u,y|Gᵢ)≦ε̂d(y,v|Gᵢ)≦ε(u→y→v)} (2)

Now, let us see how the labeling algorithm works given the hierarchical decomposition. Contrary to the decomposition process which proceeds from the lower level to higher level (like peeling), the labeling performs from the higher level to the lower level. Specifically, it first labels the core graph Gₕ and then iteratively labels the vertex at level h−1 to level 0.

Labeling Core Graph Gₕ: Theoretically, the diameter of the core graph Gₕ is no more than ε (the pairwise distance between any vertex pair in Gₕ is no more than ε), and thus no more reachability backbone is needed (Vₕ₊₁=O/). In this case, for a vertex v∈Vₕ (level(v)=h), the basic labeling can be as simple as follows:

Lₒᵤₜ(v)=Nₒᵤₜ^{┌∈/2┐}(v|Gₕ);Lᵢₙ(v)=Nᵢₙ^{┌∈/2┐}(v|Gₕ) (3)

The labeling is clearly complete for Gₕ as any reachable pair is within distance ε. Alternatively, since the core graph is typically rather small, we can also employ the existing 2-hop labeling algorithm to perform the labeling for core graphs. Given this, practically, the decomposition can be stopped when the vertex set Vₕ is small enough (typically less than 10K) instead of making its diameter less than or equal to ε.

Labeling Vertices with Lower Level i (0≦i<h): After the core graph is labeled, the remaining vertices will be labeled in a level-wise fashion from higher level h−1 to lower level (until level 0). For each vertex v at level 0≦i<h, assuming all vertices in the higher level (>i) have been labeled (Lₒᵤₜ and Lᵢₙ), then the following simple rule can be utilized for labeling v:

Lₒᵤₜ(v)=Nₒᵤₜ^{┌∈/2┐}(v|Gᵢ)∪(∪_{u∈B}_{ₒᵤₜ}_{^{∈}}_{(v|G}_{ᵢ}₎Lₒᵤₜ(u)) (4)

Lᵢₙ(v)=Nᵢₙ^{┌∈/2┐}(v|Gᵢ)∪(∪_{u∈B}_{ᵢₙ}_{^{∈}}_{(v|G}_{ᵢ}₎Lᵢₙ(u)) (5)

Basically, the label of Lₒᵤₜ(v) (Lᵢₙ(v)) at level i consists of two parts: the outgoing (incoming) ┌∈/2┐-degree neighbors of v in Gᵢ and the labels from its corresponding outgoing (incoming) backbone vertex set Bₒᵤₜ^{∈}(v|Gᵢ) (Bᵢₙ^{∈}(v|Gᵢ)). In particular, if ε=2 (the typical locality threshold), then each vertex v basically records its direct outgoing (incoming) neighbors in Gᵢ and the labels from its backbone vertex set.

Overall Algorithm: Algorithm 1 sketches the complete Hierarchical-Labeling approach. Basically, we first perform the recursive hierarchical DAG decomposition (Line 1). Then, the vertices at the core graph Gₕ will be labeled either by Formula 3 or using the existing 2-hop labeling approach (Line 2). Finally, the while-loop performs the labeling from higher level h−1 to lower level 0 iteratively (Lines 4-10), where each vertex v in the level i (Lines 5-9) will be labeled based on Formulas 4 and 5.

Algorithm 1 Hierachical-Labeling(G = (V,E))

| 1: Perform Hierarchical Decomposition of G based on Definition 2; | |
|---|---|
| 2: Labeling core graph Gₕ; | |
| 3: i ← h − 1; | |
| 4: while i ≧ 0 {Labeling Vᵢ from higher level to lower} do | |
| 5: | for each v ∈ Vᵢ \ Vᵢ₊₁ {labeling each vertex specific for Vᵢ} do |
| 6: | Lₒᵤₜ(v) ← Nₒᵤₜ^{┌∈/2┐}(v\|Gᵢ) ∪ (Lₒᵤₜ(u)) |
| 7: | Lᵢₙ(v) ← Nᵢₙ^{┌∈/2┐}(v\|Gᵢ) ∪ (U_{u∈B}_{ᵢₙ}_{^{∈}}_{(v\|G}_{ᵢ}₎ Lᵢₙ(u)) |
| 8: | end for |
| 9: | i ← i − 1; |

10: end while

### Example 4.3

FIG. 4 illustrates the Hierarchical-Labeling process, where FIG. 4(c) shows the labeling of core graphs. Note that for simplicity, each vertex by default records itself in both Lᵢₙ and Lₒᵤₜ and ε=2. FIG. 4(b) shows the labeling for vertices in V₁; and Table 1(c) illustrates the labeling of a few vertices in V₀. Taking vertex 14 for example: Lᵢₙ (14) records its direct incoming neighbors in G₁ {7, 14} (and itself), and other labels from the labels of its corresponding incoming backbone vertex set Bᵢₙ^{∈}(14|G₁)={7}. Thus, Lᵢₙ(14)={7, 14}. Now Lₒᵤₜ(14) records its direct outgoing neighbors {14, 29} and Lₒᵤₜ of vertex 40 (Bₒᵤₜ^{∈}(14|G₁)={40}).

### 4.2 Algorithm Correctness and Complexity

In the following, we first prove the correctness of the Hierarchical-Labeling algorithm, that is, that it produces a complete labeling: for any vertex pair (u, v), u→v iff Lₒᵤₜ(u)∩Lᵢₙ(v) 6=O/. We then discuss its time complexity.

Theorem 1

The Hierarchical-Labeling approach (Algorithm 1) produces a complete labeling for each vertex v in graph G, such that for any vertex pair (u, v): u→v iff Lₒᵤₜ(u)∩Lᵢₙ(v) 6=O/.

Proof Sketch: We prove the correctness through induction: assuming Algorithm 1 produces the correct labeling for Vᵢ₊₁, then it produces the correct labeling for Vᵢ. Basically if for any vertex pair u* and v* in Vᵢ₊₁, u*→v* iff Lₒᵤₜ(u*)∩Lᵢₙ(v*) 6=O/, then we would like to show that for any vertex pair u and v in Vᵢ, this also holds. To prove this, we consider four different cases for any u and v in Vᵢ₊₁: 1) u∈Vᵢ\Vᵢ₊₁ and v∈Vᵢ\Vᵢ₊₁; 2) u∈Vᵢ\Vᵢ₊₁ and v∈Vᵢ₊₁; 3) u∈Vᵢ₊₁ and v∈Vᵢ\Vᵢ₊₁; and 4) u∈Vᵢ₊₁ and v∈Vᵢ₊₁. Since case 4 trivially holds based on the reduction and cases 2 and 3 are symmetric, we will focus on proving cases 1 and 2.

Case 1 (u∈Vᵢ\Vᵢ₊₁ and v∈Vᵢ\Vᵢ₊₁): We observe: 1) u→v with d(u, v)≦ε (local pair) iff there is x∈Vᵢ, such that d(u, x)≦┌ε/2┐ and d(x, v)≦┌ε/2┌, i.e., Nₒᵤₜ^{┐∈/2┌}(v|Gᵢ)∩Nᵢₙ^{┐∈/2┌}(v|Gᵢ)≠O/; and 2) u→v with d(u, v)>ε (non-local pair) iff there are backbone vertices u*, v*∈Vᵢ₊₁, such that d(u, u*)≦ε, d(v*, v)≦ε and u*→v*. That is, Lₒᵤₜ(u*)∩Lᵢₙ(v*)≈O/ iff there are x∈Bₒᵤₜ^{∈}(u|Gᵢ) and y∈Bᵢₙ^{∈}(v|Gᵢ), such that x→y, i.e., Lₒᵤₜ(x)∩Lᵢₙ(y)≈O/ (if there is x∈Vᵢ₊₁, such that d(u, x)≦ε and d(x, u*)≦ε, then we can always use x to replace u* for the above claim; (u*→v* then x→v*)) iff (∪_{u∈B}_{ₒᵤₜ}_{^{∈}}_{(v|G}_{ᵢ}₎Lₒᵤₜ(u))∩(∪_{u∈B}_{ᵢₙ}_{^{∈}}_{(v|G}_{ᵢ}₎Lₒᵤₜ(u))≠O/.

Case 2 (u∈Vᵢ\Vᵢ₊₁ and v∈Vᵢ₊₁): We observe 1) u→v with d(u, v)≦ε (local pair) iff either v∈Bₒᵤₜ^{∈}(u|Gᵢ) (v∈Lₒᵤₜ(u) and v∈Lᵢₙ(v)), or there is x∈Bₒᵤₜ^{∈}(v|Gᵢ), such that x→v, i.e. Lₒᵤₜ(x)∩Lᵢₙ(v)≠O/ iff (∪_{u∈B}_{ₒᵤₜ}_{^{∈}}_{(|G}_{ᵢ}₎Lₒᵤₜ(u))∩(∪_{u∈B}_{ᵢₙ}_{^{∈}}_{(v|G}_{ᵢ}₎Lₒᵤₜ(u))≠O/ and 2) u→v with d(u, v)>ε (non-local pair) iff there exists x such that x∈Bₒᵤₜ^{∈}(v|Gᵢ) and x→v, i.e. Lₒᵤₜ(x)∩Lᵢₙ(v)≠O/ iff (∪_{u∈B}_{ₒᵤₜ}_{^{∈}}_{(v|G}_{ᵢ}₎Lₒᵤₜ(u))∩(∪_{u∈B}_{ᵢₙ}_{^{∈}}_{(v|G}_{ᵢ}₎≠O/.

Thus, in all cases, we have the correct labeling for any vertex pair u and v in Vᵢ₊₁. Now, the core labeling is correct either based on the basic case where the graph diameter is no more than c or based on the existing 2-hop labeling approaches. Together with the above induction rule, we have for any vertex pair in V=V₀, the label is complete and we thus prove the claim.

Complexity Analysis: The computational complexity of Algorithm 1 comes from three components: 1) the hierarchical DAG decomposition, 2) the core graph labeling, and 3) the remaining vertex labeling for levels from h−1 to 0. For the first component, as we mentioned earlier, we can employ the FastCover algorithm [23] iteratively to extract the reachability backbone vertices Vᵢ and their corresponding graph Gᵢ. The FastCover algorithm is very efficient and to extract Gᵢ₊₁ from Gᵢ, it just needs to traverse the s neighbors of each vertex in Gᵢ₊₁. Its complexity is O(Σ_{v∈V}|Nₒᵤₜ^{∈}(v|Gᵢ)|log|Nₒᵤₜ^{∈}(v|Gᵢ)|+|Eₒᵤₜ^{∈}(v|Gᵢ)|), where Eₒᵤₜ^{∈}(v|Gᵢ) is the set of edges v can reach in ε steps. Also, we note that in practice, the vertex set Vᵢ shrinks very quickly and after a few iterations (5 or 6 typically for ε=2), the number of backbone vertices is on the order of thousands (Section 6). The total number of iterations can be limited, such as bounding h to be 10 and/or stop the decomposition when the Vᵢ is smaller than some limit such as 10K. For the second component, if the diameter is smaller than ε and Formula 3 is employed, it also has a linear cost: O(Σ_{v∈V}(|Nₒᵤₜ^{∈}(v|Gₕ)|+|Eₒᵤₜ^{∈}(v|Gₕ)|+|Nᵢₙ^{∈}(v|Gₕ)|+|Eᵢₙ^{∈}(v|Gₕ)|)). Employing the existing 2-hop labeling approach, the cost can be O(|Vₕ|4). However, since |Vₕ| is rather small, the cost can be acceptable and in practice (Section 6), it is also quite efficient. Finally, the cost to assign labels for all the remaining vertices is linear to their neighborhood cardinality and the labeling size of each vertex. It can be written as O(Σ_{v∈Vi\Vi+1}(|Nₒᵤₜ^{∈}(v|Gₕ)|+|Eₒᵤₜ^{∈}(v|Gₕ)|+|Nᵢₙ^{∈}(v|Gₕ)|+|Eᵢₙ^{∈}(v|Gₕ)|)+ML, where M is the maximal number of vertices in the backbone vertex set and L is the maximal number of vertices in any Lᵢₙ or Lₒᵤₜ.

We note that for large graphs, the last component typically dominates the total computational cost as we need to perform list merge (set-union) operations to generate Lₒᵤₜ and Lᵢₙ for each vertex. However, compared with the existing hop labeling approach, Hierarchical-Labeling is significantly cheaper as there is no need for materializing transitive closure and the set-cover algorithm. The experimental study (Section 6) finds that the labeling size produced by the Hierarchical-Labeling approach is comparable to that produced by the expensive set-cover based optimization.

### 5. Distribution Labeling

The Hierarchical-Labeling approach provides a fast alternative to produce a complete reachability oracle. Its labeling is dependent on a reachability-based hierarchical decomposition and follows a process similar to the classical transitive closure computation, where the transitive closure of all incoming neighbors are merged to produce the new transitive closure. However, the potential issue is that when merging Lₒᵤₜ and Lᵢₙ of higher level vertices for the lower level vertices, this approach does not (and cannot) check whether any hop is redundant, i.e., their removal can still produce a complete labeling. Given the current framework, it is hard to evaluate the importance of each individual hop as they being cascaded into lower level vertices. Recall that for a vertex v, when computing its Lₒᵤₜ(v) and Lₒᵤₜ(v), its corresponding backbone vertex sets (Bₒᵤₜ^{∈}(v) and Bᵢₙ^{∈}(v)) only eliminate those redundant backbones if they can be linked through a local vertex (Formulas 1 and 2). Thus even if u∈Bₒᵤₜ^{∈}(v), it may still be redundant as there is another vertex u′∈Bₒᵤₜ^{∈}(v) such that u′→u (but d(u′, u) is large). However, this issue is related to the difficulty of computing transitive reduction as mentioned earlier.

In light of these issues, we ponder the following: Can we perform labeling without the recursive hierarchical decomposition? Can we explicitly confirm the “power” or “importance” of an individual hop as it is being added into Lₒᵤₜ and Lᵢₙ? In this disclosure, we provide positive answers to these questions and along the way, we discover a simple, fast, and elegant labeling algorithm, referred to as Distribution-Labeling: 1) the recursive hierarchical decomposition is replaced with a simple total order of vertices (the order criterion can be as simple as a basic function of vertex degree); 2) each hop is explicitly verified to be added into Lₒᵤₜ and Lᵢₙ only when it can cover some additional reachable pairs, i.e., it is non-redundant. Surprisingly, the labeling size produced by this approach is even smaller than the set-cover approach on all the available benchmarking graphs used in the recent reachability studies (Section 6).

In Subsection 5.1, we first introduce a simple yet fundamental observation of hop-covering (given a hop, what vertex pairs can it cover), which is the basis for the Distribution-Labeling algorithm; and Subsection 5.2, we present the labeling algorithm and discuss its properties.

### 5.1 Hop Coverage and Labeling Basis

We first formally define the “covering power” of a hop and then study the relationship of two vertices in terms of their “covering power”.

Definition 3

(Hop Coverage) For vertex v, its coverage Cov(v) is defined as TC⁻¹(v)×TC(v)={(u, w): u→v and v→w}. Note that TC⁻¹(v) is the reverse transitive closure of v which includes all the vertices reaching v. If for any pair in (u, w)∈Cov(v), Lₒᵤₜ(u)∩Lᵢₙ(w)≠O/, then we say Cov(v) is covered by the labeling. We also say Cov(v) can be covered by v if each vertex u reaching v (u∈TC⁻¹(v)) has v∈Lₒᵤₜ(u) and each vertex w being reached by v has v∈Lᵢₙ(w) (w∈TC(v)).

Given this, the labeling Lₒᵤₜ and Lᵢₙ is complete if it covers Cov(V)=∪_{v∈V} Cov(v), i.e., for any (u, w)∈Cov(V). To achieve a complete labeling, let us start with Cov(v, v′)=Cov(v)∪Cov(v′). We study how to use only v and v′ to cover Cov(v, v′). Specifically, we consider the following question: assuming v has been recorded by Lₒᵤₜ(u) for every u∈TC⁻¹(v) and by Lᵢₙ(w) for every w∈TC(v), then in order to cover the reachability pairs in Cov(v, v′) and only v′ can serve as the hop, what vertices should record v′ in their Lₒᵤₜ and Lᵢₙ?

To answer this question, we consider three cases: 1) v and v′ are incomparable, i.e., v−/→v′ and v←/−v′; 2) v′→v; and 3) v→v′. For the first case, the labeling is straightforward: each u∈TC⁻¹(v′) needs to record v′∈Lₒᵤₜ(u) and each w∈TC(v′) needs to record v′∈Lᵢₙ(u). Note that in the worst case, this is needed in order to recover pairs as TC⁻¹(v′)×{v′} and {v′}×TC(v′). For Cases 2 and 3, Lemma 2 provides the answer.

Lemma 2

Let Lₒᵤₜ(u)={v} for every u∈TC⁻¹(v) and Lᵢₙ(w)={v} for every w∈TC(v). If v′→v, then with Lₒᵤₜ(u)={v, v′} for u∈TC⁻¹(v′) and Lᵢₙ(w)={v′} for w∈TC(v′)\TC(v) (other labels remain the same), Cov({v, v′}) is covered (using only hops v and v′). If v→v′, then with Lₒᵤₜ(u)={v′} for u∈TC⁻¹(v) \TC⁻¹(v) and Lᵢₙ(w)={v, v′} for w∈TC(v′) (other labels remain the same), Cov({v, v′}) is covered (using only hops v and v′).

Proof Sketch: We will focus on proving the case where v′→v as the case v′→v is symmetric. We first note that if v′→v, then TC⁻¹ (v′)⊂TC⁻¹(v) and TC(v′)⊂TC(v). Since Cov(v)=TC⁻¹(v)×TC(v) is already covered by v, the uncovered pairs in Cov({v, v′}) can be written as:

Cov({v,v′})\Cov(v)=TC⁻¹(v′)×(TC(v′)\TC(v)).

Given this, adding v′ to Lₒᵤₜ(u) where u∈TC⁻¹ (v′) and to Lᵢₙ(w) where w∈TC(v′)\TC(v) can thus cover all the pairs in Cov({v, v′}).

Example 5.1

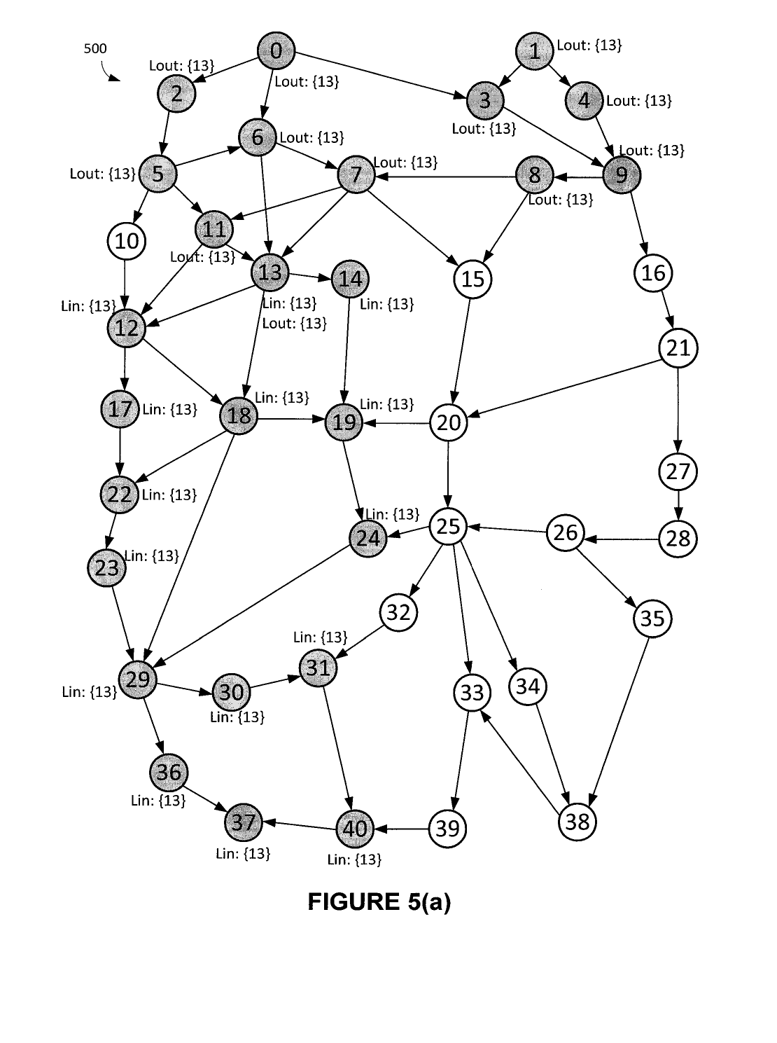

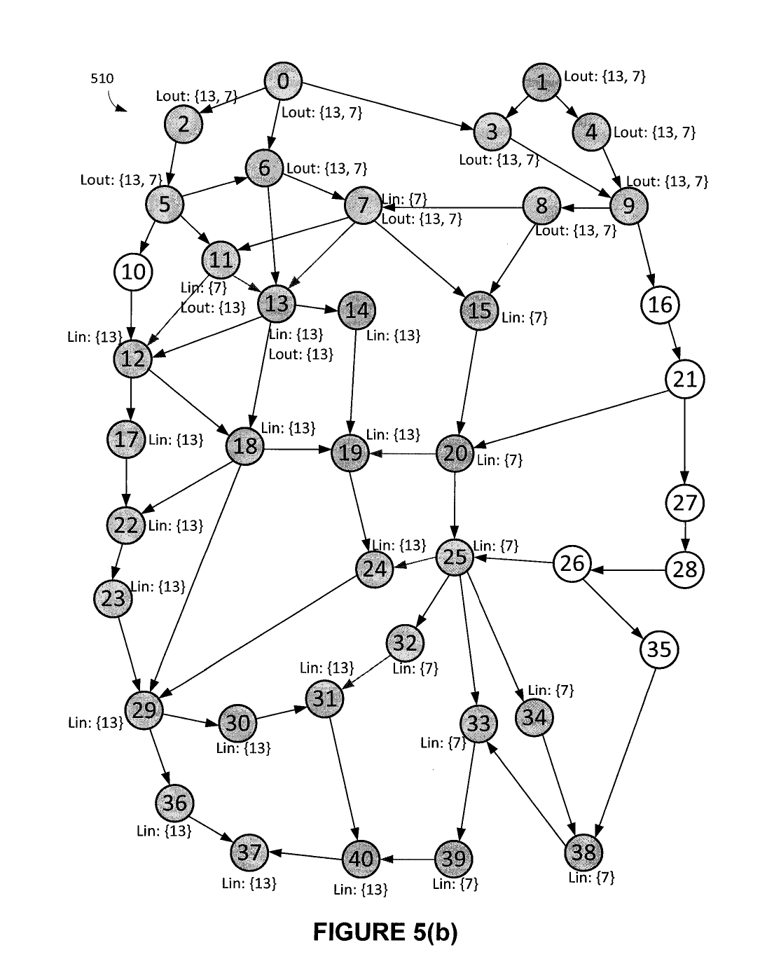

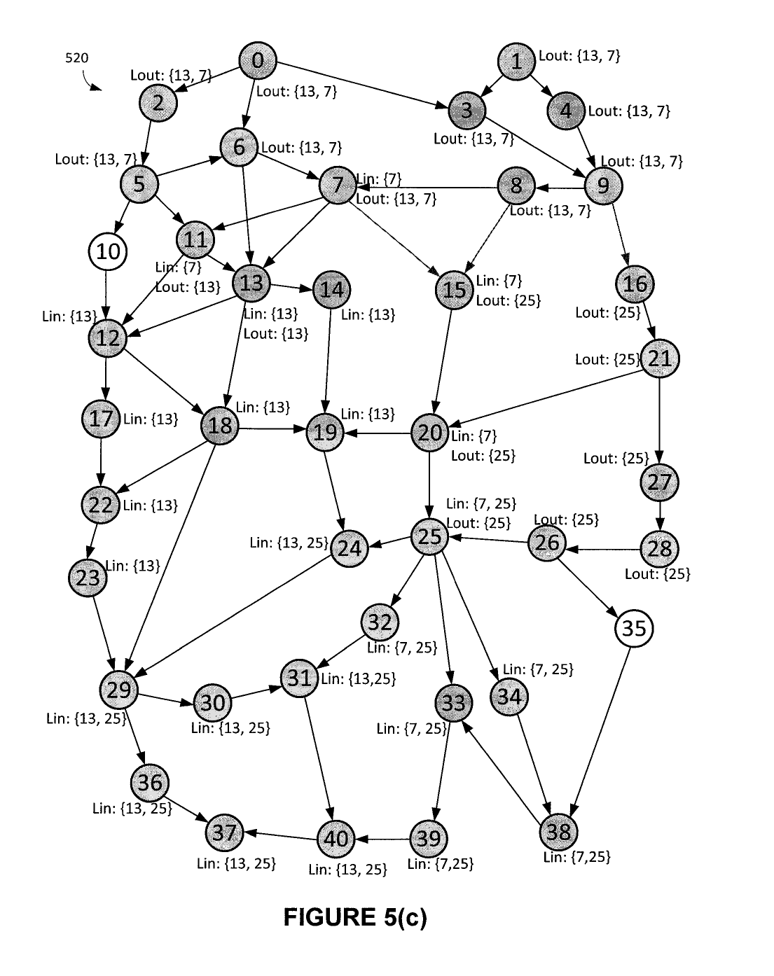

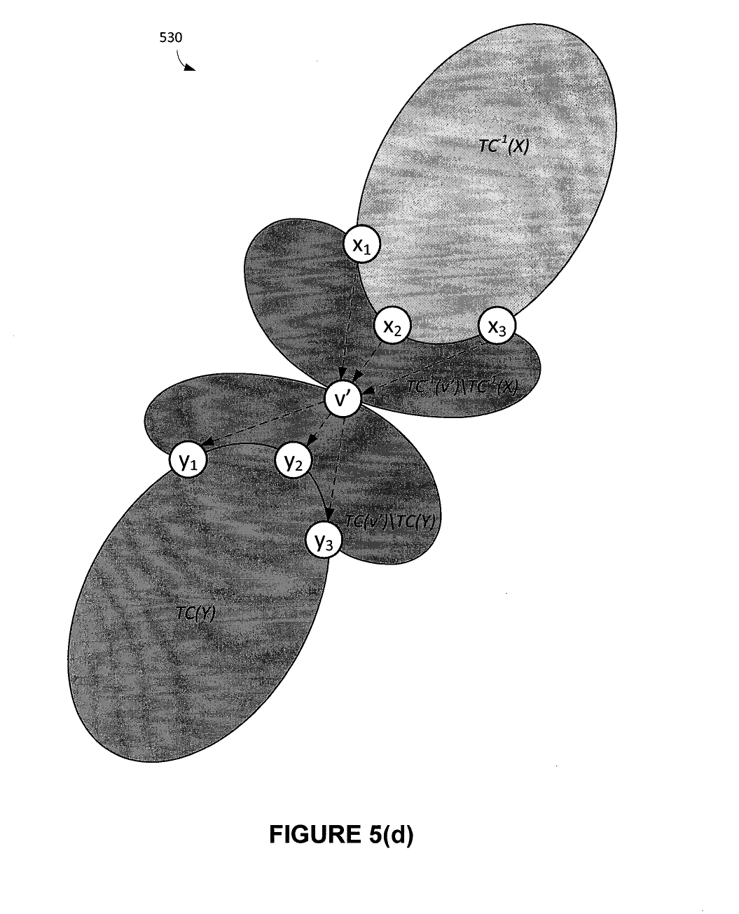

FIG. 5(a) shows the labeling for Cov(13) 500 and FIG. 5(b) shows that for Cov(13, 7) 510 where 7→13. In particular, TC⁻¹(13)=TC⁻¹(7)∪{11} and TC(13)⊂TC(7). For all u∈TC⁻¹(7), we have Lₒᵤₜ(u)={7, 13} and for all w∈Lᵢₙ(7)\Lᵢₙ(13), we have Lᵢₙ(w)={7}.

Given Lemma 2, we consider the following general scenario: for a subset of hops Vₛ⊂V, assume Lₒᵤₜ and Lᵢₙ are correctly labeled using only hops in Vₛ to cover Cov(Vₛ). Now how can we cover Cov(Vₛ∪{v′}) by adding the only additional hop v to Lᵢₙ and Lₒᵤₜ? The following theorem provides the answer (Lemma 2 can be considered a special case):

Theorem 2

(Basic Labeling) Given a subset of hops Vₛ⊂V, let Lₒᵤₜ(u)⊂Vₛ and Lᵢₙ(u)⊂Vₛ be complete for covering Cov(Vₛ), i.e., for any (u, v)∈Cov(Vₛ), Lₒᵤₜ(u)∩Lᵢₙ(v)≠O/. To cover Cov(Vₛ∪{v′}) using additional hop v′, the following labeling is complete:

Lₒᵤₜ(u)←Lₒᵤₜ(u)∪{v′},u∈TC⁻¹(v′)\TC⁻¹(X) (6)

Lᵢₙ(w)←Lᵢₙ(w)∪{v′},w∈TC(v′)\TC(Y) (7)

where X=TC⁻¹(v)∩Vs including all the vertices in Vs reaching v′ and Y=TC(v′)∩Vs including all the vertices in Vs that can be reached by v′; TC⁻¹(X)=∪_{v∈X} TC⁻¹(v) and TC(Y)=∪_{v∈Y} TC(v).

The theorem and its proof can be illustrated in FIG. 5(d) 530.

Proof Sketch: We first observe the following relationships between the (reverse) transitive closure of v′ and X, Y.

TC⁻¹(v′)⊃TC⁻¹(X);TC(v′)⊂TC(v),v∈X;

TC(v′)⊃TC(Y);TC⁻¹(v′)⊂TC⁻¹(v),v∈Y;

Thus, following the similar proof of Lemma 2, we can see that

$$Cov ( {V}_{s} ⋃ \{ {v}^{′} \} ) = Cov ( {V}_{s} ) ⋃ {TC}^{- 1} ( {v}^{′} ) \times TC ( {v}^{′} ) = Cov ( {V}_{s} ) ⋃ ( {TC}^{- 1} ( {v}^{′} ) \backslash {TC}^{- 1} ( X ) ) ⋃ {TC}^{- 1} ( X ) ) \times ( ( TC ( {v}^{′} ) \backslash TC ( Y ) ) ⋃ TC ( Y ) ) = Cov ( {V}_{s} ) ⋃ ( {TC}^{- 1} ( {v}^{′} ) \backslash {TC}^{- 1} ( X ) ) \times ( TC ( {v}^{′} ) \backslash TC ( Y ) ) ⋃ ( {TC}^{- 1} ( {v}^{′} ) \backslash {TC}^{- 1} ( X ) ) \times {⋃}_{v ∈ Y} TC ( {v}^{′} ) ⋃ {TC}^{- 1} ( X ) \times ( TC ( {v}^{′} ) \backslash TC ( Y ) ) ⋃ {TC}^{- 1} ( X ) \times TC ( Y ) = Cov ( {V}_{s} ) ⋃ ( {TC}^{- 1} ( {v}^{′} ) \backslash {TC}^{- 1} ( X ) ) \times ( TC ( {v}^{′} ) \backslash TC ( Y ) ) , \\ since \\ ( {TC}^{- 1} ( {v}^{′} ) \backslash {TC}^{- 1} ( X ) ) \times TC ( Y ) ⊆ Cov ( {V}_{s} ) ;$$

$${TC}^{- 1} ( X ) \times ( TC ( {v}^{′} ) \backslash TC ( Y ) ) ⊆ Cov ( {V}_{s} ) ;$$

$${TC}^{- 1} ( X ) \times TC ( Y ) ⊆ Cov ( {V}_{s} )$$

Thus, by adding v′ to Lₒᵤₜ(u), u∈TC⁻¹(v′)\TC⁻¹ (X) and to Lᵢₙ(w), w∈TC(v′)\TC(Y), the labeling will be complete to cover Cov(Vₛ∪{v′}).

### Example 5.2

FIG. 5(c) shows an example of Cov({13, 7}∪{25}) 520, where X={13, 7} (both can reach 25 and Y=O/. Thus 25 is added to Lₒᵤₜ(u), u∈TC⁻¹ (25)\(TC(13)ÅTC(7)) and to Lᵢₙ(w), w∈TC(25).

### 5.2 Distribution-Labeling Algorithm

In the following, based on Lemma 2 and Theorem 2, we introduce the Distribution-Labeling algorithm, which will iteratively distribute each vertex v to Lₒᵤₜ and Lᵢₙ of other vertices to cover Cov(Vₛ∪{v}) (Vₛ includes processed vertices). Intuitively, it first selects a vertex v₁ and provides complete labeling for Cov(v₁); then it selects the next vertex v₂, provides complete labeling for Cov({v₁, v₂}) based on Lemma 2. It continues this process, at each iteration i selecting a new vertex vᵢ and producing the complete labeling for Cov(Vₛ∪{vᵢ}) based on Theorem 2 where Vₛ includes all the i−1 vertices which have been processed. The complete labeling will be produced when Vₛ=V.

Given this, two issues need to be resolved for this labeling process: 1) What should be the order in selecting vertices, and 2) How can we quickly compute X (processed vertices which can reach the current vertex vᵢ) and Y (processed vertices vᵢ can reach), and identify u∈TC⁻¹(vᵢ)\TC⁻¹(X) and w∈TC(vᵢ)\TC(Y).

Vertex Order: The vertex order can be considered an extreme hierarchical decomposition, where each level contains only one vertex. Furthermore, the higher level the vertex, then the more important it is, the earlier it will be selected for covering, and the more vertices that are likely to record it in their Lₒᵤₜ and Lᵢₙ lists. There are many approaches for determining the vertex order. For instance, if following the set-cover framework, the vertex can be dynamically selected to be the cheapest in covering new pairs, i.e.,

$$\frac{\vert {TC}^{- 1} ( {v}_{i} ) \backslash {TC}^{- 1} ( X ) \vert + \vert TC ( {v}_{i} ) \backslash TC ( Y ) \vert}{\vert Cov ( {V}_{s} ⋃ \{ {v}_{i} \} ) \backslash Cov ( {V}_{s} ) \vert} .$$

However, this is computationally expensive. We may also use |Cov(vᵢ)| which measures the covering power of vertex v, but this still needs to compute transitive closure. In this study, we found the following rank function, (|Nₒᵤₜ(v)|+1)×(|Nᵢₙ(v)|+1), which measures the vertex pairs with distance no more than 2 being covered by v, is a good candidate and can provides compact labeling. Indeed, we have used a similar criterion for selecting reachability backbone. In the experimental evaluation (Section 6), we will also use this rank function for computing the distribution labeling.

Labeling Lₒᵤₜ and Lᵢₙ: Given vertex vᵢ we need to find (1) u∈TC⁻¹(vᵢ)\TC⁻¹(X), i.e., the vertices reaching vᵢ but not reaching by v such that v→vᵢ and it has a higher order (already being processed); and (2) w∈TC(vᵢ)\TC(Y), i.e., the vertices which can be reached by vᵢ but cannot be reached by v such that vᵢ→v and it has a higher order. The straightforward way for solving (1) is to perform a reversed traversal and visit (expand) the vertices based on the reversed topological order; then once the visited vertex has a higher order then vᵢ, all its descendants (including itself) will be colored (flagged) to be excluded from adding vᵢ to Lₒᵤₜ; thus vᵢ will be added to Lₒᵤₜ for all uncolored vertices during the reverse traversal process. A similar ordered traversal process can be used for solving (2). However, the (reverse) ordered traversal needs a priority queue which results in O(|V| log|V|+|E|) complexity at each iteration. In this disclosure, we utilize a more efficient approach that can effectively prune the traversal space and avoid the priority queue, which is illustrated in Algorithm 2.

In Algorithm 2, the iteration labeling process is sketched in the for each loop (Lines 2 to 15). The main procedure in computing u∈TC⁻¹(vᵢ)\TC⁻¹(X) for labeling Lₒᵤₜ is outlined in Lines 3-8. The main idea is that when visiting a vertex u, once Lₒᵤₜ(u)∩Lᵢₙ(vᵢ) is no longer empty, we can simply exclude u and its descendants from consideration, i.e., u∈TC⁻¹(X) (Lines 4-6). Intuitively, this is because there exists a vertex v, such that u→v→vᵢ and has order higher than vᵢ. Similarly, the procedure that computes w∈TC(vᵢ)\TC(Y) for labeling Lᵢₙ is outlined in Lines 9-14. Here, the condition Lᵢₙ(w)∩Lₒᵤₜ(vᵢ)≠O/ is utilized to prune w and its descendents to determine Lᵢₙ labeling. FIG. 5 illustrates the labeling process based on Algorithm 2 for the first three vertices 13, 7, and 25.

### 5.3 Completeness, Compactness, and Complexity

In the following, we discuss the labeling completeness (correctness), compactness (non-redundancy), and time complexity.

Theorem 3

(Completenss) The Distribution-Labeling algorithm (Algorithm 2) produces a complete Lₒᵤₜ and Lᵢₙ labeling, i.e., for any vertex pair (u, v), u→v iff Lₒᵤₜ(u)∩Lᵢₙ(v)≠O/.

Algorithm 2 Distribution-Labeling(G=(V,E))

1: Rank vertices in G in certain order;
2: for each vᵢ ∈ V {from higher order to lower} do

| | |
|---|---|
| 3: | Perform Reverse BFS starting from vᵢ, and for each vertex u being |
| | visited: |
| 4: | if Lₒᵤₜ (u) ∩ Lᵢₙ(vᵢ) ≠ Ø then |
| 5: | Do not add vᵢ to Lₒᵤₜ(u) nor expand u; |
| 6: | else |
| 7: | Add vᵢinto Lₒᵤₜ(u) and expand u in the reverse BFS; |
| 8: | end if |
| 9: | Perform BFS starting from vᵢ, and for each vertex w being visited: |
| 10: | if Lᵢₙ(w) ∩ Lₒᵤₜ(vᵢ) ≠ Ø then |
| 11: | Do not add vᵢ to Lᵢₙ(u) nor expand w; |
| 12: | else |
| 13: | Add vᵢ into Lᵢₙ(w) and expand w in the BFS; |
| 14: | end if |

15: end for

Proof Sketch: u∈TC⁻¹(vᵢ)\TC⁻¹(X) and 2) w∈TC(vᵢ)\TC(Y). They are symmetric and we will focus on 1). Note that for u∈TC⁻¹(vᵢ)\TC⁻¹ (X), we need to exclude vertex u′ such that u′→v→vᵢ, where v is already processed (has higher order than vᵢ). Assuming the labeling is complete for Cov(Vₛ), where Vₛ={v₁, . . . , vᵢ₋₁}, then Lₒᵤₜ(u′)∩Lᵢₙ(vᵢ)≠O/ (Line 4). If u′ should be excluded, then its descendents from the BFS traversal will also be true and should also be excluded. Furthermore, the reverse BFS can visit all vertices where this condition does not hold, i.e., Lₒᵤₜ(u)∩Lᵢₙ(vᵢ)=O/, and thus u∈TC⁻¹ (vᵢ)\TC⁻¹(X).

Theorem 3 shows that the Distribution-Labeling algorithm is correct; but how compact is the labeling? The following theorem shows an interesting non-redundant property of the produced labeling, i.e., no hop can be removed from Lᵢₙ or Lₒᵤₜ while preserving completeness. This property has not been investigated before in the existing studies on reachability oracle and hop labeling.

Theorem 4

(Non-Redundancy) The Distribution-Labeling algorithm (Algorithm 2) produces a non-redundant Lₒᵤₜ and Lᵢₙ labeling, i.e., if any hop h is removed from a Lₒᵤₜ or Lᵢₙ label set, then the labeling becomes incomplete.

Proof Sketch: We will show that 1) for any u∈TC⁻¹(vᵢ)\TC⁻¹(X), vᵢ cannot be removed from Lₒᵤₜ; and 2) for any w∈TC(vᵢ)\TC(Y), vᵢ cannot be removed from Lᵢₙ. Note that when vᵢ is being added to Lₒᵤₜ(u) and Lᵢₙ(w), it is non-redundant as the new labeling at least covers (TC⁻¹(vᵢ)\TC⁻¹(X))×{vᵢ} and {vᵢ}×TC(vᵢ)\TC(Y).

However, will any later processed vertex vⱼ, such that i<j, make vᵢ redundant? The answer is no because in this case (still focusing on the above covered pairs by vᵢ), u→vⱼ→vᵢ (or w←vⱼ←vᵢ), but the order of vᵢ is higher than vⱼ and vⱼ will not be added vᵢ into its Lₒᵤₜ or Lᵢₙ. In other words, for any vertex pair in (TC⁻¹(vᵢ)\TC⁻¹(X))×{vᵢ} or {vᵢ}×TC(vᵢ)\TC(Y), vᵢ is the only hop linking these pairs, i.e., Lₒᵤₜ(u)∩Lᵢₙ(vᵢ)={vᵢ} and Lₒᵤₜ(vᵢ)∩Lₒᵤₜ(u)={vᵢ}. Thus, v, is non-redundant for all the vertices recording it as label, i.e., Lₒᵤₜ(u), u∈TC⁻¹(vᵢ)\TC⁻¹(X) and Lᵢₙ(w),w∈TC(vᵢ)\TC(Y).

As discussed earlier, Hierarchical-Labeling does not have this property; we can see this through counter-examples. For instance, in FIG. 4(b), 17 is redundant for Lₒᵤₜ(5). However, to remove these cases, the transitive reduction would have to be performed, which is expensive. Furthermore, whether the labels produced by the existing set-cover based approach are redundant or not remains an open question though we conjecture they might be redundant.

Time Complexity: The worst case computational complexity of Algorithm 2 can be written as O(|V|(|V|+|E|)L), where L is the maximal labeling size. However, the conditions in Line 4 and 10 can significantly prune the search space, and L is typically rather small, the Distribution-Labeling can perform labeling very efficiently. In the experimental study (Section 6), we will show Algorithm 2 is on average more than an order of magnitude faster than the existing hop labeling and has comparable or faster labeling time than the state-of-the-art reachability indexing approaches on large graphs. Its labeling size is also small and surprisingly, even smaller than the greedy set-cover based labeling approaches in most of the cases. This may be evidence that the labeling of the existing set-cover based approach is redundant.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for scaling reachability computations on relatively large graphs, the method comprising:
identifying an initial graph comprising a plurality of vertices and a plurality of edges;
identifying a backbone graph within the initial graph at least in part by a graph creation module;
creating a subsequent graph comprising a scaled-down version of the initial graph, based at least in part on the backbone graph, at least in part by the graph creation module; and
computing the reachability of at least two of the vertices using at least the subsequent graph at least in part with a processor and a reachability analytics module.

2. The method of claim 1, wherein the creating a subsequent graph is accomplished at least in part by a hierarchical labeling method.

3. The method of claim 1, wherein the creating a subsequent graph is accomplished at least in part by a distribution labeling method.

4. The method of claim 1, wherein the computing the reachability of local vertices is accomplished at least in part using a search of the subsequent graph and/or the backbone graph.

5. The method of claim 1, wherein a reachability of a first processed vertice of the at least two vertices, is based at least in part on a function of vertices that can be reached by the first vertice.

6. The method of claim 5, wherein computing the reachability of a first vertice of the at least two vertices, is accomplished at least in part using a function of vertices which can reach the first vertice.

7. The method of claim 6, wherein a reachability of the at least two vertices is the Cartesian product of the function of vertices the first vertice can reach and a function of vertices that can reach the first vertice.

8. The method of claim 6, wherein a reachability of the at least two vertices is determined in part on whether the at least two vertices can reach the backbone.

9. The method of claim 5, wherein a reachability of the at least two vertices is the Cartesian product of the function of vertices the first vertice can reach and a function of vertices that can reach the first vertice.

10. The method of claim 5, wherein a reachability of the at least two vertices is determined in part on whether the at least two vertices can reach the backbone.

11. One or more computer readable storage media having program instructions stored thereon for scaling reachability computations on relatively large graphs that, when executed by a computing system, direct the computing system to at least:
identify an initial graph comprising a plurality of vertices and a plurality of edges;
identify a backbone graph within the initial graph at least in part by a graph creation module;
create a subsequent graph comprising a scaled-down version of the initial graph, based at least in part on the backbone graph at least in part by the graph creation module; and
compute the reachability of at least two of the vertices using at least the subsequent graph at least in part with a processor and a reachability analytics module.

12. The one or more computer readable storage media of claim 9, having further instructions wherein the creating a subsequent graph is accomplished at least in part by a hierarchical labeling method.

13. The one or more computer readable storage media of claim 9, having further instructions wherein the creating a subsequent graph is accomplished at least in part by a distribution labeling method.

14. The one or more computer readable storage media of claim 9, having further instructions wherein the computing the reachability of local vertices is accomplished at least in part using a search of the subsequent graph and/or the backbone graph.

15. The one or more computer readable storage media of claim 9, having further instructions wherein a reachability of a first processed vertice of the at least two vertices, is based at least in part on a function of vertices that can be reached by the first vertice.

16. The one or more computer readable storage media of claim 9, having further instructions wherein computing the reachability of a first vertice of the at least two vertices, is accomplished at least in part using a function of vertices which can reach the first vertice.

17. A method for scaling reachability computations on relatively large graphs, the method comprising:
identifying an initial graph comprising a plurality of vertices and a plurality of edges;
creating a scaled-down backbone graph of the initial graph based at least in part on a locality threshold; and
computing the reachability of at least two of the plurality vertices using at least the initial graph or the backbone graph.

18. The method of claim 15, wherein the creating a subsequent graph is accomplished at least in part by a hierarchical labeling method.

19. The method of claim 15, wherein the creating a subsequent graph is accomplished at least in part by a distribution labeling method.

20. The method of claim 15, wherein the computing the reachability of local vertices is accomplished at least in part using a search of the subsequent graph and/or the backbone graph.
